(19) United States
(12) Patent Application Publication
(10) Pub. No.: US 2026/0144269 A1
(43) Pub. Date: May 28, 2026

(54) METHOD FOR MANUFACTURING SOY YOGURT WITH SIGNIFICANTLY IMPROVED TASTE AND TEXTURE

(71) Applicant: Haneulbit Foods Inc., Gongju-si, Chungcheongnam-do (KR)

(72) Inventor: Hyeong Gwang JEON, Gongju-si (KR)

(73) Assignee: Haneulbit Foods Inc., Gongju-si, Chungcheongnam-do (KR)

(21) Appl. No.: 19/365,158

(22) Filed: Oct. 21, 2025

(30) Foreign Application Priority Data
Oct. 21, 2024 (KR) 10-2024-0143797

(51) Int. Cl. A23C 11/10

(52) U.S. Cl. CPC A23C 11/106; A23V 2400/113; A23V 2400/169; A23V 2400/519

(57) ABSTRACT

The present invention relates to a method for preparing soymilk yogurt with significantly improved taste and texture, comprising the steps of: (a) washing and soaking soybeans; (b) grinding the soybeans using a colloid mill to produce soymilk; (c) sterilizing the soymilk at 125 to 135° C. for 8 to 12 seconds; (d) concentrating the soymilk to 22 to 26 Brix; and (e) inoculating the concentrated soymilk with a lactic acid bacteria complex and fermenting the same.

### CROSS-REFERENCE TO RELATED APPLICATION

This application claims priority to and the benefit of Korean Patent Application No. 10-2024-0143797, filed on Oct. 21, 2024, the disclosure of which is incorporated herein by reference in its entirety.

### TECHNICAL FIELD

The present invention relates to a method for producing yogurt using soymilk, and more particularly, to a method for manufacturing a food product in which dairy ingredients are replaced with soymilk and the taste and texture are significantly improved through a fermentation process.

### BACKGROUND ART

Yogurt is a representative fermented food produced by fermenting milk, and it is widely popular around the world for its smooth texture and beneficial lactic acid bacteria that promote health.

However, yogurt made from milk is not suitable for individuals with lactose intolerance or milk allergies, which has led to growing interest in plant-based fermented foods as alternatives in recent years.

Among these, yogurt made from soymilk has attracted attention because it contains no cholesterol and is rich in protein and dietary fiber compared to milk.

Nevertheless, conventional methods for producing soymilk-based yogurt have several limitations, resulting in restricted commercial success.

Conventional soymilk yogurt tends to retain a strong beany odor characteristic of soymilk during the fermentation process, and its flavor often becomes bland.

While milk-based yogurt naturally develops a balanced combination of savory and tangy flavors during fermentation, soymilk fails to generate such harmonized flavors, making it difficult to meet consumer preferences. Consequently, soymilk yogurt has struggled to provide sufficient consumer satisfaction as a commercial product.

Furthermore, because soymilk has a lower fat content and a different protein structure compared to milk, the texture of fermented soymilk yogurt is often less smooth or even coarse. After fermentation, soymilk yogurt may become either watery or excessively firm, making it difficult to achieve the desired creamy mouthfeel.

In particular, the relatively large protein particles in soymilk are not uniformly dispersed, preventing proper coagulation during fermentation and resulting in a lack of smooth and consistent texture in the final product.

To improve the texture, a method involving the removal of okara (soybean residue generated during soymilk extraction) has been employed. While the removal of okara can enhance the texture of soymilk yogurt, producing a smoother and more uniform consistency, it simultaneously causes the loss of valuable nutritional components in soymilk-especially proteins and dietary fibers-during the process.

Dietary fiber is not only beneficial for intestinal health but also a key component that enhances the nutritional value of soymilk. However, when okara is removed, these valuable components are inevitably eliminated as well. As a result, although the removal of okara contributes to improving the texture of soymilk yogurt, it inevitably diminishes its nutritional value, thereby reducing its merit as a health-promoting food.

Accordingly, in the field of soymilk yogurt production technology, it has remained an important challenge to improve the flavor and aroma while providing a smooth and creamy texture, without sacrificing the inherent nutritional components of soymilk-particularly dietary fiber and protein.

In this context, there has been a strong demand for a new manufacturing method capable of significantly improving the taste and texture of soymilk yogurt while preserving as much of the original nutritional value of soymilk as possible.

### DISCLOSURE

### Technical Problem

The present invention has been devised to overcome the problems of the prior art described above, and an object of the present invention is to provide a soymilk yogurt in which the characteristic beany odor of soymilk is minimized and the overall flavor is enhanced, thereby improving the taste and aroma of the product.

### Technical Solution

According to one aspect of the present invention, there is provided a method for producing soymilk yogurt, comprising the steps of: (a) washing and soaking soybeans; (b) grinding the soybeans using a colloid mill to prepare soymilk; (c) sterilizing the soymilk at 125 to 135° C. for 8 to 12 seconds; (d) concentrating the soymilk to 22 to 26 brix; and (e) inoculating the concentrated soymilk with a lactic acid bacteria complex and fermenting it.

In one embodiment, in step (a), the soybeans may be soaked at 20 to 25° C. for 16 to 20 hours.

In one embodiment, in step (b), the soybeans may be ground using a colloid mill to obtain an average particle size of 100 to 150 μm.

In one embodiment, in step (b), after grinding, the soybeans may be homogenized under high pressure at 380 to 450 bar.

In one embodiment, in step (c), the pH of the soymilk may be adjusted to 5.5 to 7.5.

In one embodiment, in step (d), the concentration may be carried out at a low temperature of 20 to 40° C.

In one embodiment, in step (d), the concentration may be performed in two stages, comprising a first concentration at 20 to 30° C. and a second concentration at 30 to 40° C.

In one embodiment, in step (e), the lactic acid bacteria complex may comprise Lactobacillus plantarum and Lactobacillus acidophilus.

In one embodiment, the lactic acid bacteria complex may further comprise Bifidobacterium breve.

In one embodiment, prior to step (a), the method may further comprise a step of drying the soybeans and a step of dehulling the dried soybeans.

### Advantageous Effects

The method for producing soymilk yogurt according to one aspect of the present invention significantly reduces the characteristic beany odor generated during the fermentation of soymilk, thereby providing a smooth, rich flavor and aroma even after fermentation.

In addition, t method allows the soymilk yogurt to maintain a soft and creamy texture without the need to remove okara, thereby maximizing the nutritional value of the soymilk.

It should be understood that the effects of the present invention are not limited to those described above, and include all effects that can be reasonably inferred from the technical features disclosed in the detailed description or the claims of the present invention.

### MODE FOR INVENTION

The terminology used in the present specification has been selected to best describe the functions of the invention, employing general terms widely used at present. However, such terms may vary depending on the intent of a person skilled in the art, judicial precedents, or the emergence of new technologies. In certain cases, terms have been arbitrarily selected by the applicant, and in such instances, their meanings will be clearly defined in the relevant portions of the description. Accordingly, the terminology used herein should not be interpreted merely based on the literal expressions of the terms, but should be construed based on their meanings and the overall technical context of the present invention.

Unless otherwise defined, all technical and scientific terms used herein have the same meaning as those generally understood by a person of ordinary skill in the art to which the invention pertains. Terms defined in commonly used dictionaries should be interpreted as having meanings consistent with the contextual usage within the relevant technical field, and, unless explicitly defined otherwise in this application, should not be construed in an idealized or excessively formal sense.

The numerical ranges described herein include the values defining the ranges. Every upper numerical limit disclosed in the present specification includes all lower numerical limits explicitly mentioned, and every lower numerical limit includes all upper numerical limits explicitly mentioned. Furthermore, all numerical ranges disclosed herein include all narrower ranges that fall within the broader range explicitly described.

Hereinafter, embodiments of the present invention will be described in detail; however, it is to be understood that the present invention is not limited to the following embodiments.

In one aspect, the present invention provides a method for producing soymilk yogurt, comprising the steps of: (a) washing and soaking soybeans; (b) grinding the soybeans using a colloid mill to prepare soymilk; (c) sterilizing the soymilk at 125 to 135° C. for 8 to 12 seconds; (d) concentrating the soymilk to 22 to 26 Brix; and (e) inoculating the concentrated soymilk with a lactic acid bacteria complex and fermenting it.

The method for producing soymilk yogurt provides a process consisting of a series of steps to obtain a final fermented soymilk yogurt product.

The method includes sequential operations-washing, grinding, sterilization, and concentration—to properly prepare soymilk prior to fermentation, followed by fermentation to complete the final product. Each of these steps contributes to improving the overall product quality, including the taste, aroma, and texture of the soymilk yogurt, while also creating an optimal environment in which lactic acid bacteria can act effectively during the fermentation process.

In the method for producing soymilk yogurt, step (a) includes washing and soaking soybeans to prepare them for processing; step (b)) includes finely grinding the soybeans using a colloid mill to obtain soymilk; step (c) involves sterilizing the soymilk at a temperature of 125 to 135° C. for 8 to 12 seconds, thereby eliminating microorganisms while preserving the nutritional components of the soymilk.

Subsequently, step (d) includes concentrating the soymilk to 22 to 26 Brix to increase the solid content, and finally, step (e) includes inoculating the concentrated soymilk with a lactic acid bacteria complex and fermenting it.

Accordingly, the method for producing soymilk yogurt may be configured as a series of procedures designed to optimize the condition of soymilk before fermentation and to obtain a soymilk yogurt having improved smoothness and flavor after fermentation.

### (a) Step

The step (a) relates to the process of washing and soaking soybeans.

Step (a) serves as an initial preparation stage in the soymilk yogurt manufacturing process, in which the soybeans are conditioned to be suitable for subsequent fermentation and grinding. This step includes washing and soaking operations.

The soybeans refer to Glycine max, which is suitable for the production of soymilk and soymilk yogurt. Glycine max is a primary source of plant-based protein and fat, widely used in the food industry due to its high nutritional value. It is recognized as a complete protein source that provides all essential amino acids necessary for the human body.

Soybeans are also rich in dietary fiber, isoflavones, and unsaturated fatty acids, playing an important role in promoting health functionality. Owing to the superior quality of its protein among plant-based foods, soybeans serve as a key raw material for enhancing the nutritional value of soymilk and yogurt.

The washing process removes dust, foreign matter, mold spores, and other contaminants from the surface of the soybeans. This can be achieved by rinsing the soybeans several times with clean water or by gently stirring them by hand to detach contaminants from the surface.

For example, 1 kg of soybeans may be washed in 20 to 30 liters of water by gently stirring by hand for 5 to 10 minutes. During washing, the water may be replaced multiple times to achieve cleaner beans.

Alternatively, mechanical scrubbing equipment or pressurized water jets may be used, and the washing process can be modified according to the manufacturing environment.

If the washing process is insufficient, microbial contamination may occur during fermentation, whereas excessive washing may cause physical damage to the soybeans. Therefore, washing should be carried out under optimal time and intensity conditions.

The soaking process involves immersing the washed soybeans in water for a predetermined period so that they can adequately absorb moisture. During soaking, water uniformly penetrates into the interior of the soybeans, softening them and facilitating the subsequent grinding and fermentation processes.

According to one embodiment, in step (a), the soybeans may be soaked at a temperature of 20 to 25° C. for 16 to 20 hours.

For example, the soaking may be performed at 20 to 25° C. for 16 to 20 hours, such that the washed soybeans may be immersed in water at 25° C. for 18 hours to ensure adequate hydration.

If the soaking temperature is below 20° C., the soybeans may not soften sufficiently, making uniform grinding and fermentation difficult in subsequent steps. Conversely, if the temperature exceeds 25° C., the soybeans may become overly softened, leading to deterioration in taste and flavor.

In addition, if the soaking time is less than 16 hours, the soybeans may not absorb enough moisture, resulting in poor grinding and fermentation. When the soaking time exceeds 20 hours, the soybeans may absorb excessive water, leading to physical damage, imbalance in texture, or degradation of flavor in the subsequent process.

In one embodiment, the method may further comprise, prior to step (a), a drying step for the soybeans and a dehulling step for the dried soybeans.

Since freshly harvested soybeans generally have a high moisture content, they may be dried to a moisture level of about 10 to 20%. This drying step enables long-term storage and strengthens the structure of the soybeans, allowing for more uniform grinding during the subsequent milling process. The dried soybeans exhibit increased physical strength, thereby improving the efficiency of the grinding process.

The dried soybeans may then be dehulled. The dehulling step removes the outer hull, leaving only the soybean cotyledons, which contributes to a smoother texture of the soymilk and improves the quality of the yogurt obtained after fermentation.

Since the soybean hull contains a relatively low protein content and may interfere with achieving a smooth texture during fermentation, it is preferable to remove the hull.

Through this pre-treatment process, soymilk yogurt can be produced by grinding whole soybeans-including the okara (soybean residue)—without requiring a separate okara removal step.

Soymilk produced without removing the okara retains rich dietary fiber and preserves the full nutritional composition of the soybean, resulting in a yogurt product with enhanced nutritional value and greater health benefits.

### (b) Step

The step (b) relates to a process of preparing soymilk by grinding soybeans using a colloid mill.

Step (b) is an essential stage in which the soybeans are finely ground by means of a colloid mill to produce soymilk.

A colloid mill operates by placing soybeans between two high-speed rotating disks, generating strong shear forces that break down the soybeans into fine particles. Through this process, the texture and particle size of the soymilk are determined, making it a critical step that influences the overall quality of the product in subsequent processes.

Utilizing a colloid mill allows for precise control of particle size, enabling the production of extremely small and uniform soybean particles. This grinding process significantly improves the texture and dispersibility of soymilk, ensuring that lactic acid bacteria can be evenly distributed and effectively act during the fermentation process.

Soymilk obtained through colloid milling contains finely dispersed proteins and fats, which allow the product to maintain a smooth and creamy texture even after fermentation. When the soybean particles are sufficiently reduced in size, phase separation within the soymilk does not occur, and a stable emulsion state can be maintained.

Furthermore, the use of a colloid mill ensures that the nutritional components of the soybeans are evenly distributed throughout the soymilk, thereby enhancing its nutritional value. When proteins and lipids are uniformly ground, lactic acid bacteria can efficiently utilize these nutrients during fermentation, leading to improved quality of the resulting soymilk yogurt.

In addition, the strong shear forces generated by the colloid mill help suppress the beany odor inherent to soybeans, thereby markedly improving the flavor and aroma of the fermented soymilk yogurt.

In one embodiment, in step (b), the soybeans may be ground using a colloid mill to obtain an average particle size of 100 to 150 μm.

As the particle size of the soybeans decreases, the physical properties of the soymilk are greatly improved, and proteins and lipids can be uniformly dispersed, allowing lactic acid bacteria to act evenly during the fermentation process.

If the particle size is smaller than 100 μm, the soymilk may become excessively thin, resulting in an undesirable texture after fermentation. Conversely, if the particle size exceeds 150 μm, the soybean particles may not be sufficiently reduced in size, leading to a coarse texture in the fermented soymilk.

Accordingly, setting the particle size within the above range plays a critical role in maintaining optimal soymilk quality.

In one embodiment, after grinding the soybeans in step (b), the soymilk may be homogenized under high pressure at 380 to 450 bar.

After the colloid milling process, the homogenization step may be performed at a pressure of 380 to 450 bar to further disperse the soybean proteins and lipids, thereby maximizing the physical stability of the soymilk.

During homogenization, particles within the soymilk are more uniformly dispersed, and the size of fat globules is reduced, resulting in a smoother and creamier texture.

When the pressure is below 380 bar, the homogenization may be insufficient, leading to inferior physical properties of the soymilk. When the pressure exceeds 450 bar, thermal stress may be applied to the nutritional components of the soymilk, potentially causing quality degradation.

Therefore, it is preferable to control the homogenization pressure appropriately to ensure both product quality and physical stability.

### (c) Step

The step (c) relates to a process of sterilizing the soymilk at 125 to 135° C. for 8 to 12 seconds.

Step (c) is a process in which the soymilk is sterilized at a high temperature for a short duration to eliminate microorganisms and ensure the safety of the product.

This sterilization process employs an Ultra-High Temperature (UHT) treatment, which effectively suppresses microbial activity and eliminates pathogenic bacteria in the soymilk.

The specified temperature and time ranges are suitable for creating a clean environment for fermentation while preserving the nutritional components of the soymilk to the greatest extent possible.

If the sterilization temperature is below 125° C., microorganisms may not be completely removed, potentially causing contamination during fermentation. Conversely, if the temperature exceeds 135° C., the proteins and nutrients in the soymilk may be degraded, and the flavor and texture of the soymilk may be adversely affected.

When the sterilization time is shorter than 8 seconds, the sterilization effect may be insufficient, whereas exceeding 12 seconds may result in increased nutrient loss. Accordingly, the sterilization conditions are preferably set to ensure product safety while maintaining the nutritional integrity of the soymilk.

In step (c), the pH of the soymilk may be adjusted to a range of 5.5 to 7.5, and this pH condition can play a crucial role in both the sterilization efficiency and the maintenance of soymilk quality.

By controlling the pH within the range of 5.5 to 7.5, coagulation or denaturation of soy proteins during the sterilization process can be minimized. In particular, when the pH becomes too low (approaching acidic conditions) during heat treatment, the soybean proteins may rapidly denature and aggregate, resulting in a coarse or non-uniform texture of the soymilk.

Such protein aggregation may lower the quality of the soymilk yogurt during fermentation and can lead to phase separation or physical instability of the soymilk.

Furthermore, the pH of the soymilk serves as a key factor during fermentation, as it can be suitably adjusted to provide an optimal environment for the activity of fermenting microorganisms. Within this pH range, lactic acid bacteria can actively initiate fermentation under favorable conditions.

If the pH is lower than 5.5, fermentation may proceed too rapidly in subsequent steps, resulting in an uneven texture or excessive acidity in the yogurt. Conversely, when the pH exceeds 7.5, fermentation may not proceed efficiently, causing reduced activity of lactic acid bacteria and non-uniform fermentation, thereby lowering the overall quality of the soymilk yogurt.

Accordingly, maintaining the pH within the range of 5.5 to 7.5 contributes to optimizing the texture and taste of the final soymilk yogurt.

### (d) Step

The step (d) relates to a process of concentrating the soymilk to achieve a concentration of 22 to 26 Brix.

In this step, the soymilk is concentrated to reach a solid content level suitable for fermentation, where the Brix value serves as an indicator of the solid concentration of the soymilk. By removing a portion of the moisture and increasing the ratio of solids, the texture of the yogurt obtained after fermentation becomes thicker and richer.

If the concentration is below 22 Brix, the soymilk may be too dilute, resulting in a yogurt product with insufficient creaminess after fermentation. Conversely, when the concentration exceeds 26 Brix, the fermentation may not proceed properly, leading to a deterioration in the flavor and aroma of the final soymilk yogurt. Accordingly, controlling the concentration within the range of 22 to 26 Brix is essential to maintain optimal texture and flavor after fermentation.

In one embodiment, in step (d), the concentration may be carried out at a low temperature of 20 to 40° C.

Low-temperature concentration allows for an increase in the solid content of the soymilk while preserving its nutritional components and improving the efficiency of the subsequent fermentation process.

When the concentration temperature is below 20° C., the concentration rate may become too slow, extending the processing time and increasing energy consumption. In contrast, when the temperature exceeds 40° C., the risk of denaturation of proteins and lipids in the soymilk increases, which can degrade the quality of the final product.

In other concentrating the soymilk at high temperatures may lead to the loss of heat-sensitive nutrients such as proteins and vitamins, as well as undesirable changes in texture. In contrast, performing concentration under low-temperature conditions minimizes heat-induced damage, thereby maintaining the nutritional integrity of the soymilk.

Since the proteins and lipids contained in soymilk are susceptible to thermal denaturation, low-temperature concentration is particularly important for preserving the nutritional value of the soymilk.

Furthermore, low-temperature concentration contributes to maintaining the physical stability of the soymilk, as it minimizes protein coagulation and fat separation during processing, ensuring a smooth and uniform texture even after concentration.

In one embodiment, in step (d), the concentration may be carried out in two stages, wherein the first concentration is performed at 20 to 30° C., followed by a second concentration at 30 to 40° C.

In the first concentration step, the soymilk is slowly concentrated at a relatively low temperature to partially remove moisture while preventing thermal degradation of the nutritional components. After the first concentration, the second concentration is performed at 30 to 40° C. to further increase the concentration of the soymilk.

During the second concentration step, moisture is more rapidly evaporated, and the ratio of solids is adjusted to the final target range of 22 to 26 Brix.

If the concentration temperature is below 30° C., the evaporation rate may be too slow, causing the process to take excessively long. Conversely, if the temperature exceeds 40° C., the proteins in the soymilk may denature, negatively affecting the texture and flavor of the final fermented product.

Since the first concentration is carried out at a relatively low temperature, the proteins and lipids in the soymilk are not denatured by heat, and the nutritional components remain intact. As a result, the texture of the soymilk yogurt becomes smoother and creamier, and the uniformity of the texture is ensured. During the second concentration, rapid evaporation occurs, increasing the solid content of the soymilk and resulting in a richer flavor and denser texture after fermentation.

Through this two-stage concentration process, the yogurt can develop a balanced flavor profile, including mild sourness and umami richness, ultimately providing a smooth, nutty, and full-bodied soymilk yogurt.

### (e) Step

The step (e) relates to a process of inoculating the concentrated soymilk with a lactic acid bacteria complex and fermenting it.

In step (e), the lactic acid bacteria perform fermentation of the soymilk, during which the proteins and lipids in the soymilk are denatured and restructured, resulting in a smooth and creamy texture. Through fermentation, the characteristic beany odor of soymilk is reduced, while both the taste and aroma are significantly improved.

During this process, the lactic acid bacteria convert the nutritional components of the soymilk into more bioavailable forms and impart probiotic properties that promote intestinal health.

As the lactic acid bacteria metabolize within the soymilk, lactic acid is produced, and the pH gradually decreases, leading to the formation of the characteristic mild acidity and smooth texture of soymilk yogurt.

In one embodiment, in step (e), the lactic acid bacteria complex may comprise Lactobacillus plantarum and Lactobacillus acidophilus.

Lactobacillus plantarum plays a critical role in fermentation by producing organic acids that lower the pH, thereby improving the flavor and aroma of the soymilk, and also functions as a beneficial probiotic that supports digestive health.

Lactobacillus acidophilus contributes to the fermentation process by softening the texture of the soymilk and regulating lactic acid production, ensuring uniform fermentation. Accordingly, the combination of these two bacterial strains enables stable fermentation and enhances the flavor and texture of the fermented soymilk yogurt.

At this time, the lactic acid bacteria complex may further include Bifidobacterium breve.

The Bifidobacterium breve acts as a beneficial microorganism in the intestine, serving as a probiotic that improves intestinal health, and during the fermentation process, it can soften the flavor and aroma of the soymilk and appropriately regulate acidity.

When Bifidobacterium breve is used as a fermentation strain within the lactic acid bacteria complex, the quality of the soymilk yogurt after fermentation can be further improved, its functional health benefits can be enhanced, and by regulating the microbial balance, a stable product quality can be maintained over an extended period after fermentation.

After inoculating the lactic acid bacteria, the fermentation time and temperature are factors that determine the quality of the yogurt, and generally, lactic acid fermentation may be carried out at 37 to 43° C.

This temperature range is suitable for allowing lactic acid bacteria actively function and to complete fermentation by decomposing the proteins and lipids in the soymilk.

If the fermentation time is too short, the lactic acid bacteria may not be sufficiently activated, and fermentation may end in an incomplete state. Conversely, if the fermentation time is too long, the acidity of the yogurt may become excessively high, producing a strong sour taste undesirable to consumers.

Therefore, the fermentation time is generally appropriate at about 8 to 12 hours, and within this range, detailed adjustments may be made according to the fermentation temperature and bacterial strains used.

In addition, during the fermentation process, pH change can serve as an important indicator. As fermentation progresses, the lactic acid bacteria generate lactic acid, gradually decreasing the pH of the soymilk, and generally, upon completion of fermentation, the pH may decrease to around 4.5.

This pH indicates that fermentation by the lactic acid bacteria has been sufficiently completed, and an appropriate level of acidity can optimize the flavor and texture of the yogurt.

If fermentation proceeds excessively and the pH drops below 4.0, the yogurt may develop an excessively sour taste and a coarse texture. Therefore, it is necessary to continuously monitor the pH during fermentation and to terminate the process at an appropriate time.

After completion of the fermentation, a process of immediately cooling the product to a low temperature may follow.

Even after fermentation is completed, the lactic acid bacteria may continue to remain active; therefore, the fermented yogurt may be rapidly cooled to 4° C. or lower to suppress bacterial activity and terminate fermentation.

Through this process, the quality of the yogurt can be maintained, and excessive post-fermentation progression can be prevented. If cooling is not properly carried out, the acidity of the yogurt may continue to increase, and the texture may separate or become excessively denatured.

The fermented soymilk yogurt inoculated with lactic acid bacteria contains a rich amount of beneficial microorganisms such as probiotics, and can be utilized as a functional food product that supports intestinal health.

The lactic acid produced during fermentation helps eliminate the characteristic beany odor of soymilk and contributes to forming a smooth and creamy texture. The fermented soymilk yogurt can be further processed into various forms—for example, distributed under refrigerated conditions, or blended with additional ingredients such as fruits, nuts, or grains to create diverse flavors.

The fermented soymilk yogurt may be packaged in various forms to meet consumer preferences. For instance, it may be marketed as plain yogurt, distributed as a drinkable type, or applied as a functional product. Additionally, after low-temperature pasteurization, it may be distributed in a form suitable for long-term storage.

Meanwhile, since product stability during distribution is crucial, the fermented soymilk yogurt should maintain a stable level of viable lactic acid bacteria under refrigerated or frozen storage conditions, and strict management of storage conditions may be required to prevent product spoilage.

The present invention will be described in further detail through the following embodiments; however, it should be understood that the invention is not limited to these embodiments.

### Example 1

1 kg of soybeans was prepared and washed several times with clean water. After thoroughly rinsing with water to remove dust and foreign substances remaining on the soybeans, the soybeans were soaked in water at 22° C. for approximately 18 hours.

The soaked soybeans became softened and were thus suitable for subsequent grinding. The soaked soybeans were ground using a colloid mill to an average particle size of 130 μm, during which process the proteins and lipids of the soybeans were uniformly dispersed to produce soymilk.

The ground soymilk was sterilized at 130° C. for 10 seconds to eliminate microorganisms. During the sterilization process, the pH of the soymilk was maintained at 6.8 to prevent protein denaturation and to ensure the physical stability of the soymilk.

The sterilized soymilk was concentrated under conditions of 30° C. until reaching 24 Brix, thereby rendering the concentrated soymilk suitable for fermentation.

A lactic acid bacteria complex consisting of Lactobacillus plantarum and Lactobacillus acidophilus was inoculated into the concentrated soymilk to initiate fermentation.

Fermentation was carried out at 38° C. for approximately 10 hours, during which the soymilk was transformed into a smooth and creamy soymilk yogurt.

### Example 2

Soymilk yogurt was prepared in the same manner as in Example 1, except that the soymilk ground using a colloid mill was subjected to homogenization using a high-pressure homogenizer at 420 bar.

### Example 3

Soymilk yogurt was prepared in the same manner as in Example 1, except that the sterilized soymilk was first slowly dehydrated at 25° C. and then subjected to a second concentration at 35° C.

### Example 4

Soymilk yogurt was prepared in the same manner as in Example 3, except that the soymilk ground using a colloid mill was subjected to homogenization using a high-pressure homogenizer at 420 bar.

### Example 5

Soymilk yogurt was prepared in the same manner as in Example 1, except that a lactic acid bacteria complex consisting of Lactobacillus plantarum, Lactobacillus acidophilus, and Bifidobacterium breve was used.

### Example 6

Soymilk yogurt was prepared in the same manner as in Example 4, except that a lactic acid bacteria complex consisting of Lactobacillus plantarum, Lactobacillus acidophilus, and Bifidobacterium breve was used.

### Comparative Example 1

Soymilk yogurt was prepared in the same manner as in Example 1, except that the soybeans were ground and soymilk was produced using a commonly available commercial blender instead of a colloid mill.

### Comparative Example 2

Soymilk yogurt was prepared in the same manner as in Example 1, except that the soybeans were ground and soymilk was produced using a disk mill instead of a colloid mill.

### Comparative Example 3

Soymilk yogurt was prepared in the same manner as in Example 1, except that the soybeans were ground to an average particle size of 25 μm.

### Comparative Example 4

Soymilk yogurt was prepared in the same manner as in Example 1, except that during the sterilization process, the pH of the soymilk was maintained at 5.0.

### Comparative Example 5

Soymilk yogurt was prepared in the same manner as in Example 1, except that the sterilized soymilk was concentrated to 24 Brix under conditions of 45° C.

### Comparative Example 6

Soymilk yogurt was prepared in the same manner as in Example 1, except that Lactobacillus plantarum was used instead of the lactic acid bacteria complex.

### Comparative Example 7

Soymilk yogurt was prepared in the same manner as in Example 1, except that Streptococcus thermophilus was used instead of the lactic acid bacteria complex.

### Comparative Example 8

Soymilk yogurt was prepared in the same manner as in Example 1, except that Bifidobacterium longum was used instead of the lactic acid bacteria complex.

### Evaluation Results-Sensory Evaluation

The yogurts prepared in the Examples and Comparative Examples were evaluated by a panel of 30 trained experts.

Each panelist performed a sensory evaluation on taste, texture, and flavor using a 9-point hedonic scale, and the mean values were calculated. The results are shown in Table 1 below.

(Preference scale: 1=very poor, 9=excellent)

TABLE 1

| Classification | Taste | Texture | Flavor |
|---|---|---|---|
| example 1 | 8.4 | 8.2 | 8.5 |
| example 2 | 8.4 | 8.5 | 8.6 |
| example 3 | 8.6 | 8.3 | 8.8 |
| example 4 | 8.6 | 8.7 | 8.9 |
| example 5 | 8.8 | 8.3 | 8.9 |
| example 6 | 9.1 | 8.9 | 9.2 |
| Comparative Example 1 | 7.2 | 6.8 | 7.2 |
| Comparative Example 2 | 7.4 | 6.5 | 6.9 |
| Comparative Example 3 | 7.6 | 7.4 | 7.5 |
| Comparative Example 4 | 7.6 | 7.5 | 7.4 |
| Comparative Example 5 | 7.2 | 7.1 | 6.5 |
| Comparative Example 6 | 7.2 | 7.6 | 7.1 |
| Comparative Example 7 | 6.8 | 7.4 | 6.9 |
| Comparative Example 8 | 7.1 | 7.6 | 7.3 |

Referring to Table 1, the yogurts of Examples 1 to 6 were evaluated to have significantly higher scores in terms of taste, texture, and flavor compared with the Comparative Examples.

According to the sensory evaluation results of the Examples and Comparative Examples, the soymilk yogurts prepared in the Examples exhibited overall superior ratings for taste, texture, and flavor compared with those of the Comparative Examples.

Specifically, the yogurts of Examples 1 to 6 recorded high scores ranging from 8.4 to 9.1 for taste, from 8.2 to 8.9 for texture, and from 8.5 to 9.2 for flavor, with Example 6 receiving the highest scores in all evaluation categories.

Example 6, which employed a lactic acid bacteria complex composed of Lactobacillus plantarum, Lactobacillus acidophilus, and Bifidobacterium breve and underwent high-pressure homogenization at 420 bar, exhibited notably enhanced overall product quality.

In contrast, the Comparative Examples showed lower scores, with ratings ranging from 6.5 to 7.6 in taste, texture, and flavor.

In particular, Comparative Examples 1 and 2, which used a blender and a disk mill instead of a colloid mill for grinding, exhibited uneven particle size distribution, resulting in a coarse texture and insufficient suppression of the characteristic beany odor of soymilk, thereby receiving lower scores in both taste and flavor.

Comparative Example 3, in which the soybeans were ground to an average particle size of 250 μm, had a coarse texture and uneven fermentation, leading to reduced scores in both taste and flavor.

Comparative Example 4, in which the pH of the soymilk was maintained at 5.0 during sterilization, exhibited insufficient resulting in a weak sourness and shallow flavor.

Comparative Example 5, in which the soymilk was concentrated at 45° C., showed denaturation of proteins caused by high-temperature concentration, producing a coarse texture and a decrease in flavor quality.

Furthermore, Comparative Examples 6 to 8, which used single lactic acid bacterial strains instead of the lactic acid bacteria complex, exhibited non-uniform fermentation, resulting in less smooth texture and lower flavor quality.

These results indicate that the specific processing conditions employed in the present invention-such as the use of a lactic acid bacteria complex, fine grinding using a colloid mill, and high-pressure homogenization-played a critical role in improving the taste, texture, and flavor of the soymilk yogurt.

The foregoing description of the present invention is intended merely as an illustration, and it will be understood by those skilled in the art to which the invention pertains that various modifications and alterations can be made in other specific forms without departing from the technical spirit or essential features of the invention.

Therefore, the embodiments described above are to be regarded as exemplary in every respect and not as limiting.

For example, individual components described as being implemented in a single form may be realized in a distributed manner, and likewise, components described as being distributed may be implemented in a combined form.

The scope of the present invention is defined by the appended claims, and all modifications or variations derived from the meaning and scope of the claims and their equivalents are to be construed as being included within the scope of the present invention.

1. A method for producing soymilk yogurt, comprising the steps of:
(a) washing and soaking soybeans;
(b) grinding the soaked soybeans using a colloid mill to prepare soymilk;
(c) sterilizing the soymilk at 125 to 135° C. for 8 to 12 seconds;
(d) concentrating the soymilk to 22 to 26 brix; and
(e) inoculating the concentrated soymilk with a lactic acid bacteria complex and fermenting it.

2. The method for producing soymilk yogurt according to claim 1, wherein in step (a), the soybeans are soaked at 20 to 25° C. for 16 to 20 hours.

3. The method for producing soymilk yogurt according to claim 1, wherein in step (b), the soybeans are ground using a colloid mill to obtain an average particle size of 100 to 150 μm.

4. The method for producing soymilk yogurt according to claim 3, wherein in step (b), the ground soybeans are homogenized under high pressure at 380 to 450 bar.

5. The method for producing soymilk yogurt according to claim 1, wherein in step (c), the pH of the soymilk is adjusted to 5.5 to 7.5.

6. The method for producing soymilk yogurt according to claim 1, wherein in step (d), the concentration is carried out at a low temperature of 20 to 40° C.

7. The method for producing soymilk yogurt according to claim 6, wherein in step (d), the concentration is performed in two stages, comprising a first concentration at 20 to 30° C. and a second concentration at 30 to 40° C.

8. The method for producing soymilk yogurt according to claim 1, wherein in step (e), the lactic acid bacteria complex comprises Lactobacillus plantarum and Lactobacillus acidophilus.

9. The method for producing soymilk yogurt according to claim 8, wherein the lactic acid bacteria complex further comprises Bifidobacterium breve.

10. The method for producing soymilk yogurt according to claim 1, further comprising, prior to step (a), a step of drying the soybeans; and a step of dehulling the dried soybeans.
